(19) United States
(12) Patent Application Publication
(10) Pub. No.: US 2009/0117291 A1
(43) Pub. Date: May 7, 2009

(54) SHATTER PREVENTION FILM OF PROTECTIVE GLASS OF LIQUID CRYSTAL DISPLAY DEVICE

(76) Inventors: Shinya Nakajima, Tokyo (JP); Kazuta Saito, Tokyo (JP)

Correspondence Address: 3M INNOVATIVE PROPERTIES COMPANY, PO BOX 33427, ST. PAUL, MN, 55133-3427, US

(21) Appl. No.: 12/295,656

(22) PCT Filed: Apr. 4, 2007
(86) PCT No.: PCT/US07/65958

§ 371 Date: Oct. 1, 2008

(30) Foreign Application Priority Data
Apr. 11, 2006 (JP) 2006-108415

(51) Int. Cl. C08F 2/46; C09K 19/00

(52) U.S. Cl. 428/1.1; 427/521

(57) ABSTRACT

To provide a shatter prevention film of a protective glass of a liquid crystal display device capable of being formed easily and excellent in properties such as shatter prevention performance. A shatter prevention film arranged on protective glass of a liquid crystal display device, wherein the shatter prevention film is formed of a cured body of a photo curable resin and has a bonding strength of at least 0.3 N/25 mm wide and an elongation of at least 20% when measured in accordance with JIS A 5759.

### TECHNICAL FIELD

This invention relates to a shatter prevention film of protective glass of a liquid crystal display device that imparts shatter prevention performance to protective glass on a surface of a liquid crystal display device on the viewing side when the glass is smashed and shatters.

### BACKGROUND

To prevent shatter of glass when the glass is broken, it is known to attach to a glass surface a shatter prevention film including a resin film such as polyester as a substrate and an adhesive applied to the resin film (refer to Japanese Unexamined Patent Publication (Kokai) No. 2004-338365, for example).

When such a shatter prevention film is attached to the glass surface, the film must be cut in accordance with the size of the glass, and it has been difficult to uniformly attach the film to the entire glass surface without involving the entrapment of air bubbles between the film and the glass and without inviting the occurrence of wrinkles. Particularly when the glass surface has concavo-convexities, the film cannot follow the concavo-convexities and an image is seen distorted when it is viewed through the glass.

In a liquid crystal display device, particularly in a liquid crystal display of a cell phone, a projection called “barge” 2 exists round a peripheral portion of protective glass 1 as shown in FIG. 1. When the shatter prevention film 3 according to the prior art is bonded to this surface, therefore, the film 3 cannot follow the projection 2 and creates clearances 4 or wrinkles.

### SUMMARY OF THE INVENTION

The present invention aims at providing a shatter prevention film of protective glass of a liquid crystal display device that eliminates the problems of the prior art using the shatter prevention film with the adhesive, can be formed easily and is excellent in performances such as shatter prevention performance.

To solve the problems described above, in a shatter prevention film arranged on protective glass of a liquid crystal display device, the invention provides a shatter prevention film, wherein the shatter prevention film is formed of a cured body of a photo curable resin and exhibits a bonding strength of at least 0.3 N/25 mm wide and an elongation of at least 20% when measured in accordance with JIS A 5759.

In protective glass of a liquid crystal display device, the invention provides protective glass, wherein a shatter prevention film is arranged on a surface of the protective glass, and the shatter prevention film is formed of a cured body of a photo curable resin and exhibits a bonding strength of at least 0.3 N/25 mm wide and an elongation of at least 20% when measured in accordance with JIS A 5759.

In a production method of a shatter prevention film of protective glass of a liquid crystal display device, the invention provides a production method including the steps of applying a photo curable resin onto protective glass of a liquid crystal display device on the viewing side and forming a resin coating, and irradiating light to the resin coating and curing the photo curable resin to form the shatter prevention film, wherein the shatter prevention film has a bonding strength of at least 0.3 N/25 mm wide and an elongation of at least 20% when measured in accordance with JIS A 5759.

According to the invention, the shatter prevention film can be formed by applying a photo curable resin onto protective glass of a liquid crystal display device and curing the resin. Therefore, the shatter prevention film follows concavo-convexities even when such features exist on a coated surface, and the film can be easily formed.

### BRIEF DESCRIPTION OF THE DRAWINGS

FIG. 1 is a sectional view of a liquid crystal display device having a shatter prevention film bonded on the viewing side thereto according to the prior art.

FIG. 2 is a sectional view of a liquid crystal display device having a shatter prevention film arranged on the viewing side thereto according to one embodiment of the present invention.

FIG. 3 is a sectional view of a liquid crystal display device having a shatter prevention film arranged on the viewing side thereto according to another embodiment of the present invention.

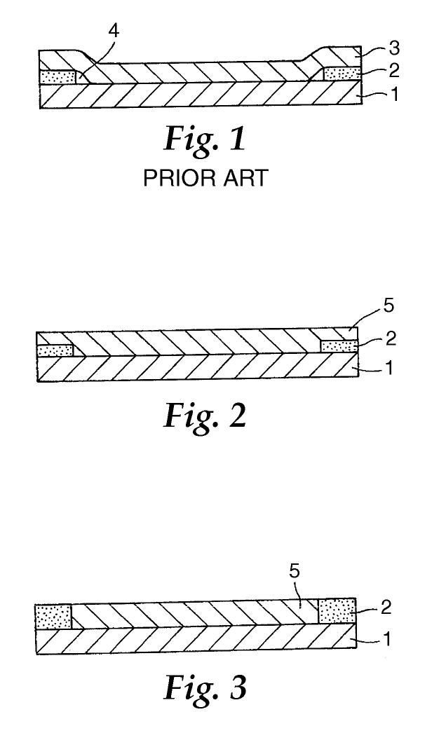

### DETAILED DESCRIPTION OF THE PREFERRED EMBODIMENTS

A liquid crystal display device according to the invention will be hereinafter explained concretely. FIG. 2 and FIG. 3 are partial enlarged schematic views of the liquid crystal display device according to embodiments of the invention. Reference numeral 1 denotes protective glass on the viewing side of the liquid crystal display device. Reference numeral 2 denotes a projection called “barge” that exists around a periphery of this protective glass. Reference numeral 5 denotes a shatter prevention film. In FIG. 2, a part of the shatter prevention film 5 closely-overlaps on the barge 2, the shatter prevention film 5 may contact with the barge 2 at its side as shown in FIG. 3.

The shatter prevention film 5 is formed by curing a photo-curable resin. The photo-curable resin is not particularly limited and is basically constituted by a photo-curable monomer or photo-curable oligomer and a photo-polymerization initiator that starts polymerization by light energy.

Specifically, it is possible to use known photo curable resins such as radical polymerization type resins and cation polymerization type resins. Preferably, 0.5 to 5 wt % of the photo polymerization initiator used for the polymerization is added to the photo curable resin and depending on cases, additives such as a thickener, a plasticizer, a dispersant, a polymerization inhibitor, etc, may be added, too.

The radical polymerization resin includes the mixtures of one or more of an acrylic resin, a urethane resin, a polyester resin and an epoxy resin with the photo polymerization initiator.

Specific examples of the acrylic resin include trimethylolpropane triacrylate, tetramethylolmethane tetraacrylate, pentaerythritol triacrylate, pentaerythritol tetraacrylate, dipentaerithritol monohydroxypentaacrylate, dipentaerythritol hexaacrylate and 1,4-butylene glycol diacrylate, 1,6-hexadiol diacrylate, polyethylene glocol diacrylate, oligoester acrylate, 2-hydroxypropyl acrylate, tetrahydrofurfuryl acrylate, acryloyl morpholine and isobornyl acrylate.

It is possible to use, as the urethane resin, those reaction products which are obtained by first reacting a dibasic acid such as phthalic acid, adipic acid, pimelic acid, succinic acid, etc, with a polyhydric alcohol such as 6-hexanediol, diethylene glycol, dipropylene glycol, etc, reacting the resulting polyester with an isocyanate compound such as tolylene diisocyanate, methanediphenyl isocyanate, etc, to obtain urethane, and further reacting the resulting urethane with a hydroxyacrylate such as 2-ethylhexyl acrylate, 2-hydroxyethyl acrylate, 2-hydroxypropyl acrylate, etc.

It is possible to use, as the polyester resin, those reaction products which are obtained by reacting a polyhydric alcohol such as ethylene glycol, 1,4-butane diol, diethylene glycol, polyethylene glycol, pentaerithritol, etc, with a polybasic acid such as phthalic acid, maleic acid, trimellitic acid, succinic acid alkenylsuccinic acid, etc.

It is possible to use, as the epoxy resin, those reaction products which are obtained by reacting bisphenolA-epichlorohydrin, phenol novolak-epichlorohydrin, alicyclic type epoxy resin and acrylic acid.

The photo radical polymerization initiator is not limited as long as it can generate the radical by the operation of light. Examples include 4-phenoxydichloroacetophenone, 4-t-butyl-dichloroacetophenone, diethoxyacetophenone, 2-hydroxy-2-methyl-1-phenylpropane-1-one, 1-(4-isopropylenephenyl)-2-hydroxy-2-methylpropane-1-one, 4-(2-hydroxyethoxy)-phenyl(2-hydroxy-2-propyl)ketone, 1-hydroxycyclohexylphenylketone, 2-methyl-1-[4-(methylthio)phenyl]-2-morphorynopropane-1, benzoin, benzoin methyl ether, benzoin ethyl ether, benzoin propyl ether, benzoin isobutyl ether, benzyl methyl ketal, benzophenone, benzoylbenzoic acid, methyl benzoylbenzoate, 4-phenylbenzophenone, hydroxybenzophenone, 4-benzoyl-4′-methyldiphenyl sulfide, 3,3′-dimethyl-4-methoxybenzophenone, thioxanthone, 2-chlorothiooxanethone, 2-methylthiooxanethone, 2,4-dimethylthiooxanethone, isopropylthiooxanethone, camphorquinone, dibenzosuberone, 2-ethylanthraquinone, 4′,4″-diethylisophthalophenone, 3,3′,4,4′-tetra(t-butylperoxycarbonyl)benzophenone, α-acyloxyme ester, acylphosphine oxide, methylphenylglyoxylate, 9,10-phenanthrenequinone, 4-(2-hydroxyethoxy)phenyl-(2-hydroxy-2-propyl)ketone, and so forth. Preferred especially among them are benzyl methyl ketal, 1-hydroxycyclohexylphenyl ketone, benzoylisopropyl ether, 4-(2-hydroxyethoxy)-phenyl(2-hydroxy-2-propyl)ketone and 2-hydroxy2-methyl-1-phenylpropane-1-on.

In the cation polymerization type resin containing the epoxy resin and an epoxy diluent as main components, the cation polymerization is started by adding the photo cation polymerization initiator and irradiating light.

The photo cation polymerization initiator is activated when light is irradiated thereto and generates a cation polymerization initiation product. This initiator can initiate the polymerization at relatively low energy, too. The photo cation polymerization initiator may be of an ionic light acid generation type or a nonionic light acid generation type. As the ionic light acid generation type, it is possible to use onium salts such as aromatic diazonium salts, aromatic halonium salts, aromatic sulfonium salts, and organic metal complexes such as iron-arene complex, titanocene complex, arylsilanol-aluminum complex, etc. As the nonionic light acid generation type, it is possible to use nitrobenzyl esters, sulfonic acid derivatives, phosphates, phenolsulfonates, diazonapthoquinone, N-hydroxyimide sulfonate, and so forth.

Fine powdery silica, organic bentonite and montomorillonite can be used as the thickener. Phthalate type plasticizers, polyester type plasticizers, phosphate type plasticizers and chlorine type plasticizers can be used as the plasticizer. Water-soluble high molecular weight organic compounds having a polar group such as polyvinyl alcohol, polyvinyl pyrrolidone and cellulose ether can be used as the dispersant. Hydroquinone, phenothiazine, etc, can be used as the polymerization inhibitor. The photo curing wavelength of the photo curable resin is 450 nm or below and is preferably within the range of 250 to 380 nm.

The shatter prevention film 5 is formed by applying the photo curable resin onto the protective glass 1 of the liquid crystal display device and curing the resin. Because the resin is a liquid, it follows the shape of concavo-convexities 2 even when they exist on the surface of the protective glass 1, and uniformly adheres to the protective glass and to the concavo-convexities 2 without leaving any clearances between the resin and the protective glass 1. The shatter prevention film 5 substantially free from defects can be formed by curing this resin.

The application of this photo curable resin to the protective glass 1 can be made by an ordinary coating method such as a roll coat method or a spin coat method.

The shatter prevention film 5 of the protective glass of the liquid crystal display device according to the invention must have the following properties:
Bonding strength: at least 0.3N/25 mm wide
Elongation: at least 20%

Incidentally, these values are measured in accordance with JIS A 5759.

When the bonding strength is less than 0.3 N/mm wide, the shatter prevention film 5 may peel off from the protective glass 1 when impact is imparted. When the elongation is less than 20%, the impact may not be absorbed when it is applied to the glass, and the glass may shatter and/or scatter. The shatter prevention film according to the invention preferably has a breaking strength of at least 5 N/25 mm wide. When the breaking strength is less than 5 N/25 mm wide, the shatter prevention film 5 may be simultaneously shattered when the protective glass 1 is smashed by the impact.

The shatter prevention film preferably has a thickness of 10 to 10,000 μm. The shatter prevention effect cannot be acquired when the film thickness is less than 10 μm, and the resin cannot be easily cured when the film thickness is greater than 10,000 μm. When the invention is applied to a liquid crystal display device of mobile electronic appliances such as a cell phone or PDA, the film thickness is preferably 10 to 1,000 μm. When the thickness is greater than 1,000 μm, the mobile electronic appliance itself becomes extremely thick and cannot be easily carried around. Incidentally, the term “shatter prevention effect” means the effect of preventing smashed glass from breaking the shatter prevention film and shattering.

To allow the shatter prevention film 5 to satisfy the performances described above, it is necessary to appropriately select the kind of the photo curable resin, its composition, the photo curing condition, and so forth.

### EXAMPLES

The following materials were used as the photo curable resin.

### Oligomer

oligomer A: urethane acrylate (UV-6100B, product of Nippon Gosei Kagakusha K.K., “Nippon Gosei”)

oligomer B: urethane acrylate (UV-33100B, product of Nippon Gosei

oligomer C: urethane acrylate (UV-3000B, product of Nippon Gosei

oligomer D: urethane acrylate (UV-3520AC, product of Nippon Gosei)

### Monomer

monomer A: 2-hydroxypropyl acrylate (“Light Ester HOP-A”, product of Kyoeisha Kagakusha K.K.)

monomer B: 1,6-hexanediol diacrylate (HDODA, product of Dial UCB Co.)

monomer C: tetrahydrofurfuryl acrylate (product of Kyoeisha Kagakusha K.K.)

monomer D: acryloyl morpholine (product of Kojinsha K.K.)

monomer E: isobornyl acrylate (“Light Acrylate IB-XA”, product of Kyoeisha Kagakusha K.K.)

### Photo Polymerization Initiator

Initiator: “Darocure 1173”, trade mark, product of Ciba-Geigy Co.

The materials described above were blended into the compositions tabulated in Table 1 and a suitable amount of each composition was dropped to the center of a glass surface and was uniformly expanded from above with a PET film. Ultraviolet rays having an irradiation intensity of 30 mW/cm² at 360 nm were irradiated through this PET film and the resin was cured. The PET film was thereafter peeled and a film of a cured resin was formed on the glass surface.

The property values of the resulting sample, that is, the bonding strength, breaking strength and elongation of the film, were measured in accordance with JIS A 5759. The thickness of the film was 100 μm and the tensile speed was kept constant at 100 mm/min. A metal ball of 68 g was freely dropped from a height of 300 mm to crash glass and the film condition was observed with eye. The result was shown in Table 1.

TABLE 1
Properties of shatter prevention film and shatter prevention effect

| | | shatter | bonding | strength at | |
|---|---|---|---|---|---|
| | | prevention | strength | break | elongation |
| No. | composition | effect | [N/25 mm] | [N/25 mm] | [%] |
| Example 1 | oligomer A/monomer A/monomer | yes | 0.3 | 7.3 | 20 |
| | B/initiator = 60/20/20/1 | | | | |
| Example 2 | oligomer C/monomer | yes | 4.0 | 7.3 | 20 |
| | B/initiator = 60/40/1 | | | | |
| Example 3 | oligomer B/monomer A/monomer | yes | 14.8 | 7.5 | 125 |
| | C/initiator = 50/40/10/1 | | | | |
| Comparative | oligomer A/monomer | no | 0.04 | 7.3 | 10 |
| Example 1 | B/initiator = 60/40/1 | | | | |
| Comparative | oligomer D/monomer D/monomer | no | 0.3 | 8.1 | 5 |
| Example 2 | E/initiator = 30/25/45/1 | | | | |
| Comparative | oligomer A/monomer A/monomer | no | 0.2 | 8.2 | 15 |
| Example 3 | B/initiator = 60/8/32/1 | | | | |

It was confirmed that when the metal ball was dropped to break the glass in Examples 1 to 3, the broken pieces remained attached to the shatter prevention film but did not shatter. In Comparative Example 1, on the other hand, the shatter prevention film 5 peeled from the protective glass 1 when the impact was applied. In Comparative Example 2, the shatter prevention film 5 could not absorb the impact and was broken when the impact was applied. In Comparative Example 3, the shatter prevention film 5 could not absorb the impact and was broken when the impact was applied.

1. A shatter prevention film arranged on protective glass of a liquid crystal display device, wherein said shatter prevention film is formed of a cured body of a photo curable resin and has a bonding strength of at least 0.3 N/25 mm wide and an elongation of at least 20% when measured in accordance with JIS A 5759.

2. A shatter prevention film of protective glass of a liquid crystal display device as defined in claim 1, wherein said photo curable resin is an ultraviolet curable resin.

3. A shatter prevention film of protective glass as defined in claim 2, wherein said ultraviolet curable resin is either a radical polymerization curing resin or a cation polymerization curing resin.

4. Protective glass having arranged thereon said shatter prevention film as defined in claim 1.

5. A production method of a shatter prevention film of protective glass of a liquid crystal display device, including the steps of:
applying a photo curable resin onto protective glass of a liquid crystal display device on the viewing side and forming a resin coating; and
irradiating light to said resin coating and curing said photo curable resin to form said shatter prevention film;
wherein said shatter prevention film has a bonding strength of at least 0.3 N/25 mm wide and an elongation of at least 20% when measured in accordance with JIS A 5759.
